(19) United States
(12) Patent Application Publication
(10) Pub. No.: US 2010/0302401 A1
(43) Pub. Date: Dec. 2, 2010

(54) Image Audio Processing Apparatus And Image Sensing Apparatus

(75) Inventors: Tomoki OKU, Osaka (JP); Masahiro YOSHIDA, Osaka (JP); Makoto YAMANAKA, Kobe City (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/731,240

(22) Filed: Mar. 25, 2010

(30) Foreign Application Priority Data
May 28, 2009 (JP) 2009-128793

(51) Int. Cl. H04N 5/225; H04N 5/04; G09G 5/00; H04R 3/00

(52) U.S. Cl. 348/222.1; 348/500; 345/634; 381/92; 348/E05.024; 348/E05.009

(57) ABSTRACT

An image audio processing portion includes an image analysis portion for analyzing an input image, a directivity control portion for controlling a directivity of an input audio signal based on a result of analysis by the image analysis portion so as to generate an output audio signal, and a display image generating portion for generating a display image by superimposing an image indicating a state of the output audio signal on the input image. A user can recognize a state of the output audio signal by checking the display image.

### CROSS-REFERENCE TO RELATED APPLICATIONS

This application claims priority to Japanese Patent Application No. 2009-128793 filed on May 28, 2009, which is hereby incorporated by reference in its entirety.

### BACKGROUND OF THE INVENTION

1. Field of the Invention

The present invention relates to an image audio processing apparatus for performing a predetermined process on an input image signal and an audio signal that makes a pair with the image signal so as to output the result, and to an image sensing apparatus including the image audio processing apparatus.

2. Description of Related Art

Image sensing apparatuses such as a digital video camera for generating and recording an image signal and an audio signal by image sensing and sound collecting are widely available. Among the image sensing apparatuses, there is an apparatus which generates and records an audio signal in which sounds coming from a predetermined direction are emphasized (a directivity is controlled).

For instance, there is proposed an image sensing apparatus which displays an image indicating a directivity of a microphone on a monitor. In addition, there is proposed an image sensing apparatus which displays a pattern indicating a sound level or a directivity of an audio signal on a monitor in a manner superimposed on an image to be taken.

In this image sensing apparatus, since the directivity of the microphone or the audio signal, and the sound level of the audio signal are displayed on the monitor or the like, an operator can check the display so as to recognize the directivity of the audio signal or the sound level. However, even if the operator can recognize the directivity of the audio signal by the display, there is a problem that setting or adjustment of control method of the directivity for obtaining an intended audio signal becomes difficult or an operation for the same becomes complicated.

In addition, the image sensing apparatus, which displays a pattern indicating a sound level or a directivity of an audio signal on a monitor in a manner superimposed on an image to be taken, can display a sound level of a sound generated by an object within an angle of view. However, it cannot display a sound level of a sound generated by an object such as the operator outside the angle of view. Therefore, there is a problem that an operator cannot decide how to respond for obtaining an intended audio signal.

### SUMMARY OF THE INVENTION

The image audio processing apparatus of the present invention includes:

an image analysis portion for analyzing an input image indicated by an input image signal;

a directivity control portion which controls a directivity of an input audio signal to make a pair with the input image signal based on a result of the analysis by the image analysis portion, and generates an output audio signal; and

a display image generating portion for generating a display image including an image indicating a state of the output audio signal.

An image sensing apparatus of the present invention includes:

the above-mentioned image audio processing apparatus;

an image sensing portion for generating an input image signal by image sensing;

a sound collecting portion for generating an input audio signal by sound collecting; and

a display portion for displaying a display image.

### BRIEF DESCRIPTION OF THE DRAWINGS

FIG. 1 is a block diagram illustrating a structure of an image sensing apparatus according to an embodiment of the present invention.

FIG. 2 is a block diagram illustrating a structure of an image audio processing portion of Example 1.

FIG. 3 is a block diagram illustrating a structural example of a directivity control portion in the image audio processing portion of Example 1.

FIG. 4 is a diagram illustrating an example of a display image generated by a display image generating portion in the image audio processing portion of Example 1.

FIG. 5A illustrates a directivity image expressing control of emphasizing sounds coming from a wide range in a subject direction.

FIG. 5B illustrates a directivity image expressing control of emphasizing sounds coming from a narrow range in a subject direction.

FIG. 5C illustrates a directivity image expressing being omni-directional without emphasizing sounds coming from a specific direction.

FIG. 5D illustrates a directivity image expressing control of emphasizing sounds coming from a subject direction and a photographer direction.

FIG. 6A is a diagram illustrating another example of the display image generated by the display image generating portion in the image audio processing portion of Example 1.

FIG. 6B is a diagram illustrating another example of the display image generated by the display image generating portion in the image audio processing portion of Example 1.

FIG. 7 is a block diagram illustrating a structure of an image audio processing portion of Example 2.

FIG. 8 is a diagram illustrating an example of the display image generated by the display image generating portion in the image audio processing portion of Example 2.

FIG. 9 is a block diagram illustrating a structure of an image audio processing portion of Example 3.

FIG. 10 is a block diagram illustrating of a structural example of a directivity control portion for sound level detection in the image audio processing portion of Example 3.

FIG. 11 is a diagram illustrating an example of the display image generated by the display image generating portion in the image audio processing portion of Example 3.

FIG. 12A illustrates an example of a sound level detection result image indicating a sound level by a level meter.

FIG. 12B illustrates an example of a sound level detection result image indicating a sound level value by the number of arc curves and a length of the same.

FIG. 13 is a diagram illustrating another example of the display image generated by the display image generating portion in the image audio processing portion of Example 3.

### DETAILED DESCRIPTION OF THE PREFERRED EMBODIMENTS

Meanings and effects of the present invention will be apparent from the following description of an embodiment of the present invention. However, the following embodiment is merely one of embodiments of the present invention, and meanings of terms of the present invention and individual elements are not limited to the following description of the embodiment.

The embodiment of the present invention will be described below with reference to the drawings. First, an example of an image sensing apparatus of the present invention will be described.

<<Image Sensing Apparatus>>

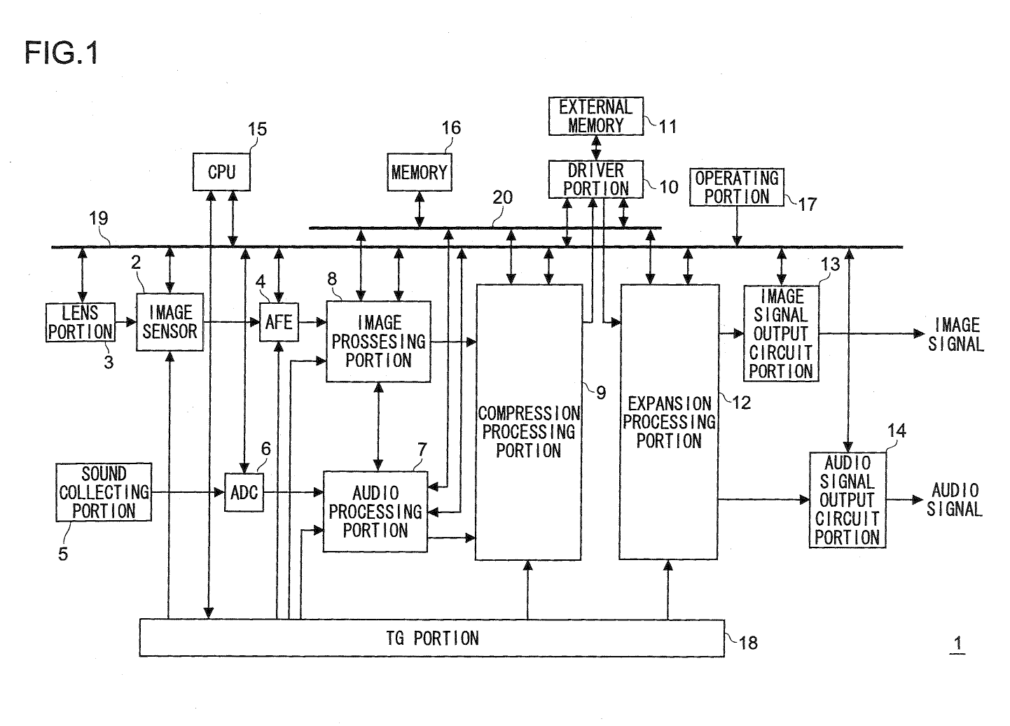

First, a structure of the image sensing apparatus will be described with reference to FIG. 1. FIG. 1 is a block diagram illustrating a structure of the image sensing apparatus according to an embodiment of the present invention.

As illustrated in FIG. 1, the image sensing apparatus 1 includes an image sensor 2 constituted of a solid-state image sensor such as a CCD (Charge Coupled Device) or a CMOS (Complementary Metal Oxide Semiconductor) sensor for converting an input optical image to an electric signal, and a lens portion 3 for forming an optical image of a subject in the image sensor 2 and for performing adjustment of light quantity and the like. The lens portion 3 and the image sensor 2 constitute an image sensing portion, and an image signal is generated by the image sensing portion. Note that the lens portion 3 includes various lenses (not shown) such as a zoom lens or a focus lens, an iris stop (not shown) for adjusting light quantity entering the image sensor 2, and the like.

Further, the image sensing apparatus 1 includes an analog front end (AFE) 4 for converting the image signal that is an analog signal output from the image sensor 2 into a digital signal and for adjusting a gain, a sound collecting portion 5 for converting input sound into an electric signal, an analog to digital converter (ADC) 6 for converting an audio signal that is an analog signal output from the sound collecting portion 5 into a digital signal, an audio processing portion 7 for performing various audio processings on the audio signal output from the ADC 6 so as to output the result, an image processing portion 8 for performing various image processing on the image signal output from the AFE 4 so as to output the result, a compression processing portion 9 for performing a compression coding process for a moving image such as the MPEG (Moving Picture Experts Group) compression method on the image signal output from the image processing portion 8 and the audio signal output from the audio processing portion 7, an external memory 11 for recording a compression coded signal that is compressed and coded by the compression processing portion 9, a driver portion 10 for recording or reproducing the image signal in or from the external memory 11, and an expansion processing portion 12 for expanding and decoding the compression coded signal read out from the external memory 11 by the driver portion 10.

In addition, the image sensing apparatus 1 includes an image signal output circuit portion 13 for converting the image signal decoded by the expansion processing portion 12 into a signal that can be displayed on a display device (not shown) such as a monitor, and an audio signal output circuit portion 14 for converting the audio signal decoded by the expansion processing portion 12 into a signal of a form that can be output from an output device (not shown) such as a speaker.

In addition, the image sensing apparatus 1 includes a central processing unit (CPU) 15 for controlling a general operation of the image sensing apparatus 1, a memory 16 for storing programs for performing processes and for temporarily storing signals when the programs are executed, an operating portion 17 for entering instructions by a photographer, including a button for starting image sensing or a button for determining various setting, a timing generator (TG) portion 18 for generating a timing control signal for synchronizing operation timings of individual portions, a bus 19 for communicating signals between the CPU 15 and the individual portions, and a bus 20 for communicating signals between the memory 16 and the individual portions.

Note that any type of external memory 11 may be used as long as it can record the image signal and the audio signal. For instance, a semiconductor memory such as an SD (Secure Digital) card, an optical disc such as a DVD, a magnetic disk such as a hard disk can be used as the external memory 11. In addition, the external memory 11 may be detachable from the image sensing apparatus 1.

Next, a fundamental operation of the image sensing apparatus 1 will be described with reference to FIG. 1. First, the image sensing apparatus 1 generates an image signal as an electric signal by photoelectric conversion of incident light from the lens portion 3 in the image sensor 2. The image sensor 2 outputs the image signal to the AFE 4 sequentially at a predetermined frame period (e.g., 1/30 seconds) in synchronization with the timing control signal supplied from the TG portion 18. Then, the image signal converted from the analog signal to the digital signal by the AFE 4 is supplied to the image processing portion 8. The image processing portion 8 converts the image signal into a signal using YUV and performs various image processings such as gradation correction, edge enhancement and the like. In addition, the memory 16 works as a frame memory so as to store the image signal temporarily when the image processing portion 8 performs the process.

In addition, the sound collecting portion 5 performs sound collecting and converts the sound into an audio signal as an electric signal so as to outputs the same. The audio signal output from the sound collecting portion 5 is supplied to the ADC 6 and is converted from the analog signal into a digital signal. Further, the audio signal converted into the digital signal by the ADC 6 is supplied to the audio processing portion 7, and various audio processings such as noise reduction are performed on it. In addition, the audio processing portion 7 processes the audio signal so as to control a directivity thereof. Note that details of the directivity and the control method thereof will be described later.

The image signal output from the image processing portion 8 and the audio signal output from the audio processing portion 7 are both supplied to the compression processing portion 9 and compressed by a predetermined compression method in the compression processing portion 9. In this case, the image signal and the audio signal are associated with each other in a temporal manner (constituting a pair) so that the image and the sound are not shifted from each other when they are reproduced. Then, the compressed image signal and audio signal are recorded in the external memory 11 via the driver portion 10.

The compressed image signal and the audio signal recorded in the external memory 11 are read out from the expansion processing portion 12 based on a photographer's instruction for reproduction input via the operating portion 17. The expansion processing portion 12 expands the compressed image signal and the audio signal read out for reproduction, and outputs the image signal for reproduction to the image signal output circuit portion 13 and the audio signal for reproduction to the audio signal output circuit portion 14, respectively. Then, the image signal output circuit portion 13 converts the image signal for reproduction into a signal of a form that can be displayed on the display device, and the audio signal output circuit portion 14 converts the audio signal for reproduction into a signal of a form that can be output from the speaker so as to output respectively. Thus, the image for reproduction is displayed on the display device, and the sound for reproduction is output from the speaker.

In addition, the image sensing apparatus 1 displays the obtained image on the display device before starting to record the obtained image or when the moving image is recorded. In this case, the image processing portion 8 generates an image signal for display and outputs the image signal to the image signal output circuit portion 13 via the bus 20. Then, the image signal output circuit portion 13 converts the image signal for display into a signal of a form that can be displayed by the display device and outputs the same.

A photographer can recognize an angle of view of the image that will be recorded or is currently recorded by confirming the image displayed on the display device. Further, a state of the audio signal controlled by the audio processing portion 7 is superimposed on the image displayed on the display device. Note that details of the image displayed on the display device and a method of generating the image will be described later.

Note that the display device and the speaker may be integrated with the image sensing apparatus 1 or may be separated from the same and connected via a terminal of the image sensing apparatus 1 and a cable or the like. However, it is preferable that the display device for displaying the image signal for display is integrated with the image sensing apparatus 1. Hereinafter, the case of a monitor in which the display device is integrated with the image sensing apparatus 1 will be described.

In addition, it is possible to adopt a structure in which the sound collecting portion 5 includes a digital microphone that outputs a digital audio signal so that the ADC 6 is eliminated.

<Image Audio Processing Portion>

Hereinafter, structures and operations of main portions of the image processing portion 8 and the audio processing portion 7 for generating the display image (hereinafter referred to as an image audio processing portion) will be described with reference to the drawings. Note that the above-mentioned image signal for display is called a “display image signal”, and the image indicated by the display image signal is called a “display image” in the following description. In addition, the image signal that is obtained by image sensing and is a base of the image signal for display is called an “input image signal”, and the image indicated by the input image signal is called an “input image”. In addition, the audio signal obtained by sound collecting when the input image signal is generated (when the input image is taken) (i.e., the audio signal to make a pair with the input image signal) is called an “input audio signal”, and the audio signal generated by controlling the directivity of the input audio signal is called an “output audio signal”.

In addition, the directivity means difference between sound collecting levels (audio signal levels obtained by sound collecting) of sounds coming from individual directions, and can be expressed by using emphasis direction or emphasis width. The emphasis direction means a direction in which the sound collecting level is relatively larger than that in other direction. In addition, the emphasis width means a range of the direction in which the sound collecting level is relatively larger than that in other direction. The larger the emphasis width is, the wider the range in which the sound is emphasized for the sound collecting. The smaller the emphasis width is, the narrower the range in which the sound is emphasized for the sound collecting. Note that the emphasis direction is not limited to one, and a plurality of emphasis directions may exist simultaneously.

In addition, emphasizing sounds coming from a certain direction is not limited to the case where a level of sound coming from a certain direction is increased absolutely but may include the case where sounds except the sound coming from a certain direction are suppressed so that a level of sound coming from a certain direction is relatively increased.

### Example 1

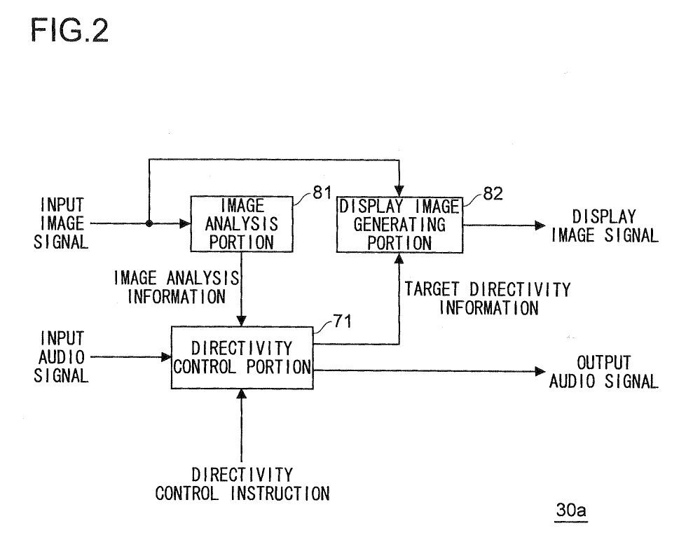

Example 1 of the image audio processing portion will be described with reference to the drawings. FIG. 2 is a block diagram illustrating a structure of the image audio processing portion of Example 1. As illustrated in FIG. 2, an image audio processing portion 30a includes an image analysis portion 81 for analyzing the input image illustrated in input image signal so as to generate image analysis information, a directivity control portion 71 which controls the directivity of the input audio signal based on the image analysis information generated by the image analysis portion 81 so as to generate the output audio signal and sets the directivity after controlling the input audio signal (i.e., the directivity of the output audio signal, which is referred to as a target directivity hereinafter) so as to generate target directivity information, and a display image generating portion 82 for generating the display image signal to be display image in which an image based on the target directivity information generated by the directivity control portion 71 is superimposed on the input image. In addition, the directivity control portion 71 changes a method of setting the target directivity based on a directivity control instruction input via the operating portion 17 by a photographer who has confirmed the display image.

Note that it is possible to adopt a structure in which the image analysis portion 81 and the display image generating portion 82 are provided to the image processing portion 8 illustrated in FIG. 1, and the directivity control portion 71 is provided to the audio processing portion 7 illustrated in FIG. 1.

Hereinafter, structures and operations of individual portions of the image audio processing portion 30a of this example will be described.

(Image Analysis Portion)

The image analysis portion 81 performs a detection process (tracking process) for sequentially detecting a target subject from the input images that are supplied sequentially, for example, and generates information indicating a position and a size of the detected target subject in the input image sequentially as the image analysis information so as to output the same. The target subject to be detected is set automatically by a program or the like when the photographer operates the operating portion 17 including the cursor key and the touch panel as the detection process starts. In this case, a character such as a shape or color of the set target subject is recognized, for example, so that a portion indicating the character is detected from the input image. Thus, the detection of the target subject is performed.

Specifically, for example, the target subject to be detected may be a face of a nonspecific person (face detection) or a face of a specific person stored in advance (face recognition). Further, it is possible to perform the detection of the target subject by recognizing a color of a part of a person having the detected face (e.g., a body region that is a region existing in the direction from the middle of the forehead toward the mouth of the detected face) and by detecting a part of the color from the input image.

In addition, it is possible to use various well-known techniques for performing the face detection. For instance, it is possible to utilize Adaboost (Yoav Freund, Robert E. Schapire, “A decision-theoretic generalization of on-line learning and an application to boosting”, European Conference on Computational Learning Theory, Sep. 20, 1995) for comparing a weight table generated from a large volume of teaching samples (face and non-face sample images) with the input image so as to perform the face detection.

Hereinafter, for a specific description, it is supposed that the image analysis portion 81 detects a human face as a target subject, and generates and outputs the image analysis information including information indicating a position and a size of the target subject (human face) in the input image.

(Directivity Control Portion)

The directivity control portion 71 obtains the image analysis information output from the image analysis portion 81, sets the target directivity based on a position or a size of the target subject, presence or absence of the same, or the like, and controls the directivity of the input audio signal so that the target directivity is realized. In addition, if the photographer inputs the directivity control instruction via the operating portion 17, the setting method of the target directivity is changed based on the instruction. In addition, the directivity control of the input audio signal is performed by controlling an input audio signal level for each direction from which the sound comes from, for example.

If the sound collecting portion 5 includes a plurality of directional microphones (which collect sounds by emphasizing sounds coming from a specific direction), the input audio signal includes a plurality of channels of signals having different emphasized directions. Therefore, if the individual channels of signal levels are controlled, the directivity can be controlled.

In addition, if the sound collecting portion 5 includes a plurality of omni-directional microphones (which collect sound uniformly without emphasizing sound coming from a specific direction), the input audio signal includes a plurality of channels of signals without a emphasized direction. In this case, for example, a phase difference of each channel signal is calculated for determining a direction from which the sound comes, and the signal level is controlled based on the direction from which the sound comes, so that the directivity can be controlled. Further, an example of this structure will be described below with reference to the drawings.

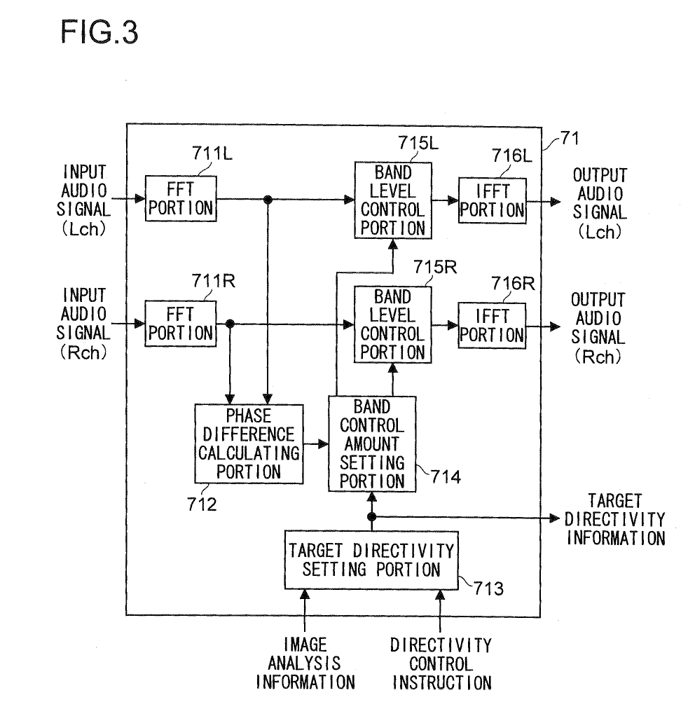

FIG. 3 is a block diagram illustrating a structural example of the directivity control portion in the image audio processing portion of Example 1. Note that, for a specific description, FIG. 3 illustrates the directivity control portion 71 which controls the directivity of the input audio signal including Lch and Rch two channels of signals.

As illustrated in FIG. 3, the directivity control portion 71 includes an FFT portion 711L for performing fast Fourier transform (hereinafter, referred to as FFT) of the Lch signal of the input audio signal so as to output the result, an FFT portion 711R for performing FFT of the Rch signal of the input audio signal so as to output the result, a phase difference calculating portion 712 which compares the Lch and the Rch signals output from the FFT portions 711L and 711R for each of predetermined frequency bands so as to calculate a phase difference of each band and to output the result, a target directivity setting portion 713 for setting the target directivity based on the image analysis information and the directivity control instruction so as to output the target directivity information, a band control amount setting portion 714 for setting control amount of each band level of each channel based on the phase difference of each band output from the phase difference calculating portion 712 so that the target directivity indicated in the target directivity information output from the target directivity setting portion 713 is realized, a band level control portion 715L for controlling each band level of the Lch signal output from the FFT portion 711L in accordance with the control amount set by the band control amount setting portion 714 so as to output the result, a band level control portion 715R for controlling each band level of the Rch signal output from the FFT portion 711R in accordance with the control amount set by the band control amount setting portion 714 so as to output the result, an IFFT portion 716L for performing inverse fast Fourier transform (hereinafter, referred to as IFFT) of the Lch signal output from the band level control portion 715L so as to output as an Lch output audio signal, and an IFFT portion 716R for performing IFFT of the Rch signal output from the band level control portion 715R so as to output as an Rch output audio signal.

Each of the FFT portions 711L and 711R performs FFT of each of the Lch and the Rch signals of the input audio signal, so as to convert from a time-base signal into a frequency-base signal. The phase difference calculating portion 712 compares the Lch and the Rch signals output from the FFT portions 711L and 711R with respect to each frequency band (e.g., the correlation between the Lch and the Rch signals is determined for each band). Thus, the phase difference between the Lch and the Rch signals (that can be considered to be a difference of distance between a sound source and each of the plurality of omni-directional microphones, or a time difference of arrival) is calculated.

The target directivity setting portion 713 sets the target directivity based on the image analysis information and changes the setting method of the target directivity based on the directivity control instruction when it is issued. Specifically, for example, the target directivity is set by the setting method of setting the direction in which the target subject indicated by the image analysis information exists as the emphasis direction, and setting the emphasis width to a value corresponding to a size of the target subject.

In addition, if the target directivity set by this setting method is different from that intended by a photographer, the photographer can change the setting method of the target directivity by inputting the directivity control instruction using the operating portion 17. Specifically, for example, if a plurality of target subjects are detected, it is possible to change the setting method of the target directivity by preventing directions in which target subjects except a specific target subject exist from being the emphasis direction, or by widening or narrowing the emphasis width. Then, the directivity setting portion 713 outputs the target directivity set as described above, as the target directivity information.

The band control amount setting portion 714 confirms the direction from which the sound comes based on the phase difference output from the phase difference calculating portion 712 and confirms the emphasis direction of the target directivity based on the target directivity information output from the target directivity setting portion 713. Then, the control amount of each band is set so that a level of the band for which the direction from which the sound comes is included in the emphasis direction is increased, and/or a level of the band for which the direction from which the sound comes is not included in the emphasis direction is suppressed.

In addition, the band level control portions 715L and 715R control the Lch and the Rch signal levels for each band based on the control amount set by the band control amount setting portion 714, so as to control the directivity of the input audio signal. Then, the IFFT portions 716L and 716R perform IFFT of the Lch and the Rch frequency-base signals output from the band level control portions 715L and 715R so as to convert them into the time-base signals, so that the Lch and the Rch signals of the output audio signal are generated and output.

Note that the above-mentioned structure of the directivity control portion 71 is merely an example, and other structure may be adopted. For instance, it is possible to delay the Rch signal of the input audio signal by a certain time and combine it with the Lch signal of the input audio signal (e.g., addition or subtraction) so as to generate the Lch signal of the output audio signal, and to delay the Lch signal of the input audio signal by a certain time and combine it with the Rch signal of the input audio signal so as to generate the Rch signal of the output audio signal. In addition, it is possible to set the delay time to a variable time based on the image analysis information.

(Display Image Generating Portion)

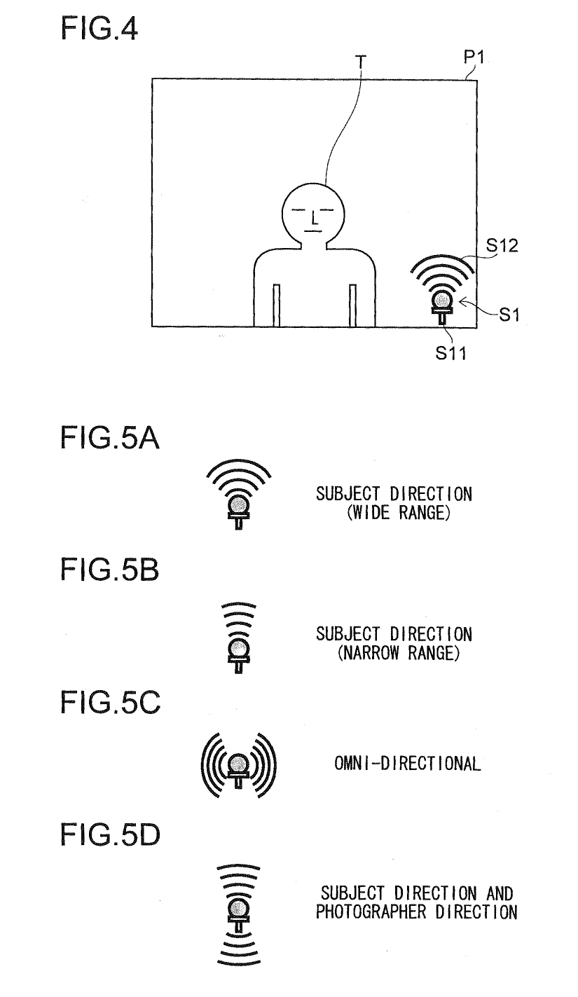

The display image generating portion 82 superimposes an image expressing the target directivity indicated by the input target directivity information on the input image so as to generate the display image expressing visually the target directivity. An example of this display image is illustrated in FIG. 4. FIG. 4 is a diagram illustrating an example of the display image generated by the display image generating portion in the image audio processing portion of Example 1.

As illustrated in FIG. 4, a display image P1 includes a directivity image S1 expressing the target directivity schematically which is superimposed on the input image at a corner (e.g., lower left corner). In addition, the directivity image S1 of this example is constituted of a schematic diagram of microphone S11 and a plurality of arcs S12 indicating a state of the set target directivity.

In addition, the display image P1 illustrates the case where the target subject T (human face) is detected from the input image by the image analysis portion 81, and the directivity control portion 71 performs control of emphasizing sounds coming from the direction in which the target subject T exists. In this case, for example, if the directivity image S1 has a structure in which long arcs S12 are provided only to the part above the schematic diagram of microphone S11, it expresses that the target directivity is set so that sounds coming from a wide range in the subject direction are emphasized (the emphasis direction is the subject direction, and the emphasis width is wide).

Various examples of the directivity image expressing the target directivity in the same manner as the method of FIG. 4 will be described with reference to FIGS. 5A to 5D. FIGS. 5A to 5D are diagrams illustrating various examples of the directivity image.

FIG. 5A illustrates the directivity image that is similar to the directivity image S1 illustrated in FIG. 4, which expresses the control of emphasizing sounds coming from a wide range in the subject direction. FIG. 5B illustrates the directivity image having a structure in which short arcs are provided only to the part above the schematic diagram of microphone, which expresses the control of emphasizing sounds coming from a narrow range in the subject direction (the emphasis direction is the subject direction, and the emphasis width is narrow in the target directivity). FIG. 5C illustrates the directivity image having a structure in which long arcs are provided to the left and the right of the schematic diagram of microphone, which expresses being omni-directional without emphasizing sound coming from a specific direction (i.e., the target directivity has no emphasis direction). FIG. 5D illustrates the directivity image having a structure in which short arcs are provided to the parts above and below the schematic diagram of microphone, which expresses the control of emphasizing sounds coming from the subject direction and the photographer direction (the emphasis direction is the subject direction and the photographer direction in the target directivity).

For instance, if a ratio of the target subject T detected from the input image in the angle of view is large, the target directivity illustrated in the directivity image of FIG. 5A may be set so that sounds coming from a wide range in the subject direction are emphasized. If the ratio of the target subject T in the angle of view is small, the target directivity illustrated in the directivity image of FIG. 5B may be set so that sounds coming from a narrow range in the subject direction are emphasized, in the target directivity to be set. Further, for example, it is possible to set the target directivity of the omni-directivity as illustrated in the directivity image of FIG. 5C if the target subject T is not detected from the input image. Further, if it is confirmed that the target subject T detected from the input image is speaking to the photographer (e.g., it is confirmed that a line of sight of the target subject T is in the photographer direction and the mouth is moving, or it is confirmed that human voice is included in the input audio signal), it may estimated that the target subject T is talking with the photographer, so as to set the target directivity as illustrated in the directivity image of FIG. 5D so that sounds coming from the subject direction and the photographer direction are emphasized.

The photographer recognizes the set target directivity by confirming the directivity image S1 included in the display image P1 displayed on the monitor. Then, if the photographer recognizes that the target directivity is different from the intended one, the directivity control instruction is issued via the operating portion 17 so that the setting method of the target directivity is changed.

In this way, it is possible to set easily the target directivity for generating the output audio signal as the photographer intends by setting the target directivity in accordance with a state of the input image. Further, it is possible to display the directivity image S1 in the display image P1 so that the photographer recognize whether or not the set target directivity is the intended one, and to constitute the setting method of the target directivity to be one that the photographer can change so that the set target directivity can be an accurate one that the photographer intends. Therefore, it is possible to generate accurately the output audio signal intended by the photographer.

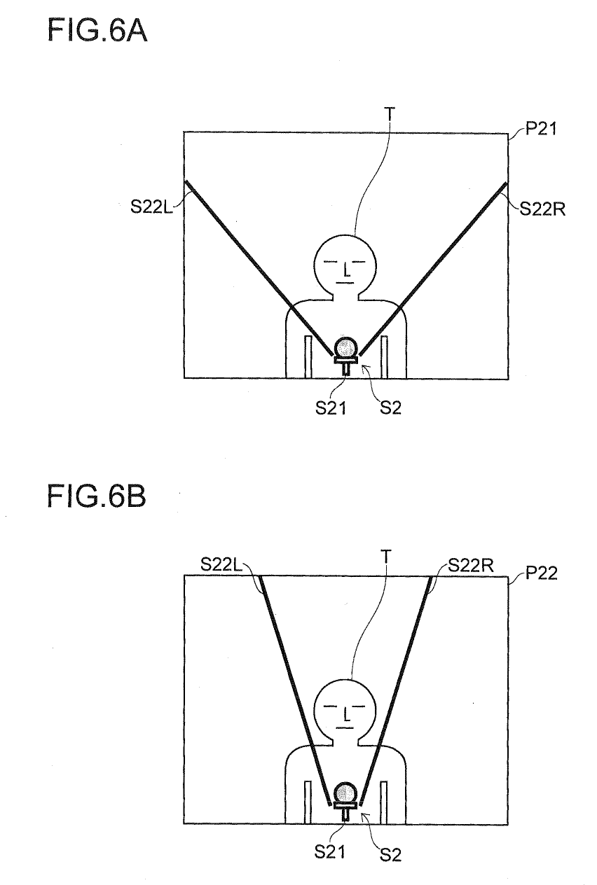

Note that in the case described above the directivity image S1 that expresses the target directivity in an abstract manner is displayed in the display image P1, but it is possible to display the directivity image that expresses the same specifically. This directivity image will be described with reference to the drawings. FIGS. 6A and 6B are diagrams illustrating another example of the display image generated by the display image generating portion in the image audio processing portion of Example 1. In addition, FIGS. 6A and 6B illustrate display images P21 and P22 before and after the photographer issues the directivity control instruction, which are the case where the target subject T is detected from the input image similarly to FIGS. 5A to 5D.

As illustrated in FIGS. 6A and 6B, a directivity image S2 of this example is constituted of a schematic diagram of microphone S21 and axes S22L and S22R indicating the emphasis direction and the emphasis width. The region between the axes S22L and S22R expresses the emphasis direction and the emphasis width. In the display image P21 illustrated in FIG. 6A, the directivity image S2 is displayed in the case of setting the target directivity having the emphasis direction of the target subject T as the center and sufficiently wide emphasis width. Here, the case where the photographer confirms the display image P21 and wants to decrease the emphasis width will be described.

In this case, as described above, the photographer issues the directivity control instruction via the operating portion 17, so as to change the setting method of the target directivity. For instance, if the operating portion 17 is constituted of a touch panel or the like provided to the monitor, the photographer selects at least one of the axes S22L and S22R displayed on the monitor as illustrated in FIG. 6A and moves the same so as to decrease the distance between the axes S22L and S22R. Thus, the directivity control instruction of decreasing the emphasis width is issued to the directivity control portion 71.

The directivity control portion 71 changes the setting method of the target directivity based on the issue directivity control instruction and sets the target directivity by the setting method after the change. The display image P22 illustrated in FIG. 6B illustrates the directivity image S2 in which the target directivity is set by the setting method after the change. In the display image P22 illustrated in FIG. 6B, the distance between the axes S22L and S22R is smaller than that of the display image P21 illustrated in FIG. 6A.

The photographer confirms the directivity image S2 in the display image P22 illustrated in FIG. 6B, so as to recognize whether or not the intended target directivity is set. If the intended target directivity is not set, the photographer further issues a directivity control instruction. On the other hand, if the intended target directivity is set, the target directivity is set by the same setting method even after the display illustrated in FIG. 6B. In other words, the target directivity having the emphasis direction of the target subject T as the center and the narrow emphasis width is set sequentially for input image signals and input audio signals after that.

In this way, since the directivity image S2 expressing the target directivity specifically is displayed in the display images P21 and P22, the photographer can recognize specifically the set target directivity and the change of the target directivity when the directivity control instruction is issued. Therefore, it is possible to set the target directivity easily. In addition, by utilizing the directivity image S2, the photographer can issue the specific directivity control instruction.

### Example 2

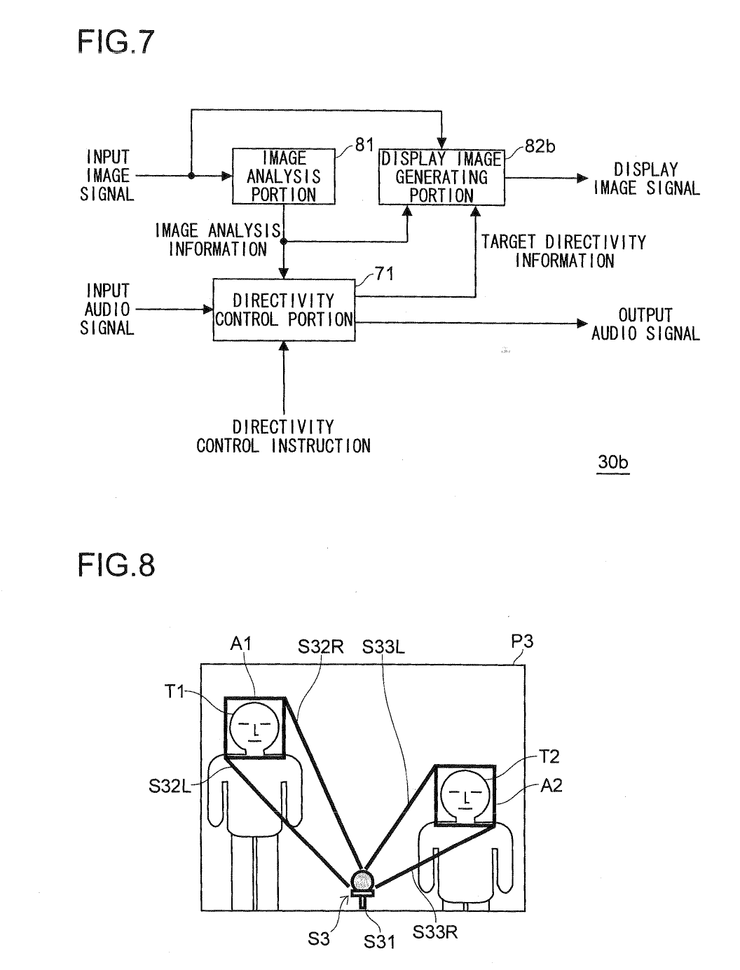

Example 2 of the image audio processing portion will be described with reference to the drawings. FIG. 7 is a block diagram illustrating a structure of the image audio processing portion of Example 2 and is corresponds to FIG. 2 illustrating the structure of Example 1. Note that in FIG. 7 a part having the same structure as in FIG. 2 is denoted by the same reference symbol, and a detailed description thereof is omitted.

As illustrated in FIG. 7, an image audio processing portion 30b includes the image analysis portion 81, the directivity control portion 71, and a display image generating portion 82b for generating a display image by superimposing on the input image an image based on image analysis information output from the image analysis portion 81 and target directivity information output from the directivity control portion 71, so as to output the display image signal.

The display image generating portion 82b of this example is different from Example 1 in that not only the image based on the target directivity information (i.e., the directivity image) but also the image based on the image analysis information (hereinafter referred to as an image analysis result image) is superimposed on the input image so as to generate the display image.

An example of the display image generated by the display image generating portion 82b of this example will be described with reference to the drawings. FIG. 8 is a diagram illustrating an example of the display image generated by the display image generating portion in the image audio processing portion of Example 2. Note that for a specific description, it is supposed that the display image generating portion 82b of this example generates the directivity image similar to the directivity image illustrated in FIGS. 6A and 6B (the image including the schematic diagram of microphone and the axes). In addition, the following description exemplifies the case where the target directivity is set so that two target subjects T1 and T2 are detected from the input image, the directions in which the target subjects T1 and T2 exist are the emphasis directions, and the emphasis widths have values corresponding to the target subjects T1 and T2, respectively.

In a display image P3 illustrated in FIG. 8, a schematic diagram of microphone S31, axes S32L and S32R indicating the emphasis direction in which the target subject T1 exists and its emphasis width, and axes S33L and S33R indicating the emphasis direction in which the target subject T2 exists and its emphasis width are displayed as a directivity image S3. Further, a face frame image A1 enclosing a human face as the target subject T1, and a face frame image A2 enclosing a human face as the target subject T2 are displayed as the image analysis result image.

In this way, in the display image P3, not only the directivity image S3 but also the image analysis result image is displayed so that the photographer who confirms the display image P3 can easily recognize the set target directivity. In particular, the photographer can easily recognize a relationship between the set target directivity and the target subjects T1 and T2 (i.e., the setting method of the target directivity).

Note that the above description exemplifies the case where the directivity image expresses specifically the target directivity as illustrated in FIGS. 6A and 6B, but the directivity image may display the target directivity in an abstract manner. However, it is preferable to use the directivity image that expresses specifically the target directivity, because the photographer can easily recognize a relationship between the target subject and the target directivity, as well as the setting method of the target directivity.

### Example 3

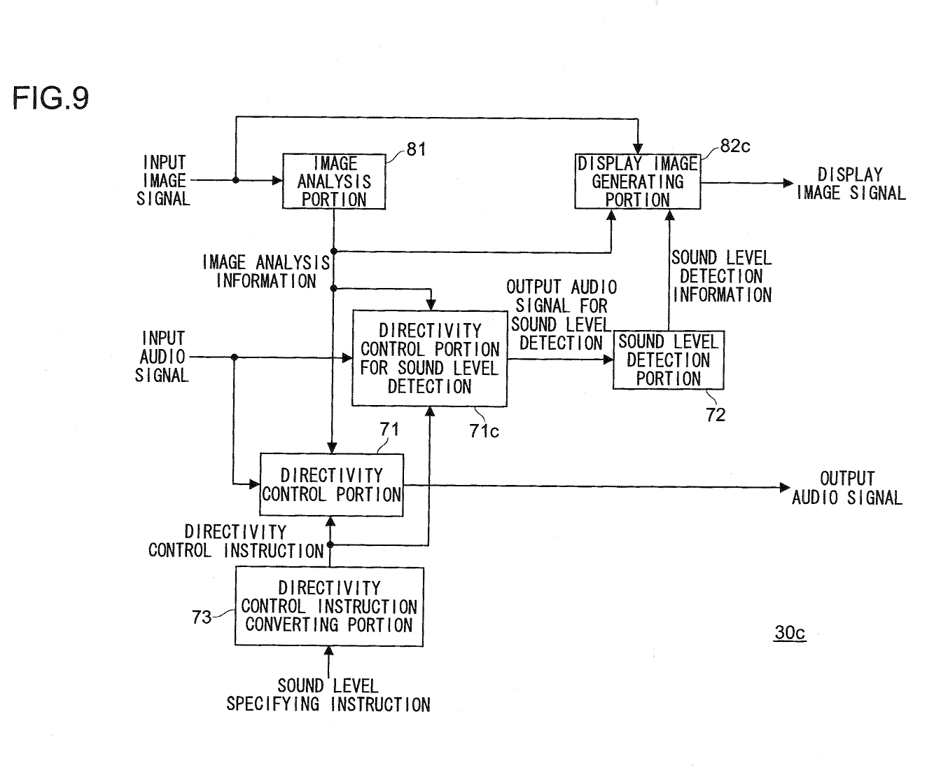

Example 3 of the image audio processing portion will be described with reference to the drawings. FIG. 9 is a block diagram illustrating the structure of the image audio processing portion of Example 3 and corresponds to FIG. 2 illustrating the structure of Example 1. Note that in FIG. 9 a part having the same structure as in FIG. 2 is denoted by the same reference symbol, and a detailed description thereof is omitted.

As illustrated in FIG. 9, an image audio processing portion 30c includes the image analysis portion 81, a directivity control portion 71c for sound level detection which controls the directivity of the input audio signal based on the image analysis information and the directivity control instruction so as to generate the output audio signal for sound level detection, a sound level detection portion 72 for detecting a sound level of the output audio signal for sound level detection output from the directivity control portion 71c for sound level detection so as to output the sound level detection information, a display image generating portion 82c which generates the display image including the image based on the image analysis information output from the image analysis portion 81 and the sound level detection information output from the sound level detection portion 72 which are superimposed on the input image so as to output the display image signal, the directivity control portion 71, and a directivity control instruction converting portion 73 which converts an issued sound level specifying instruction (that will be described later in detail) into the directivity control instruction so as to output the result to the directivity control portion 71.

The image audio processing portion 30c of this example is different from Example 1 in that the directivity control portion 71c for sound level detection, the sound level detection portion 72, and the directivity control instruction converting portion 73 are provided. In addition, the method of generating the display image by the display image generating portion 82c is also different from Example 1. Hereinafter, the directivity control portion 71c for sound level detection, the sound level detection portion 72, the display image generating portion 82c, and the directivity control instruction converting portion 73 will be described with reference to the drawings.

(Directivity Control Portion for Sound Level Detection)

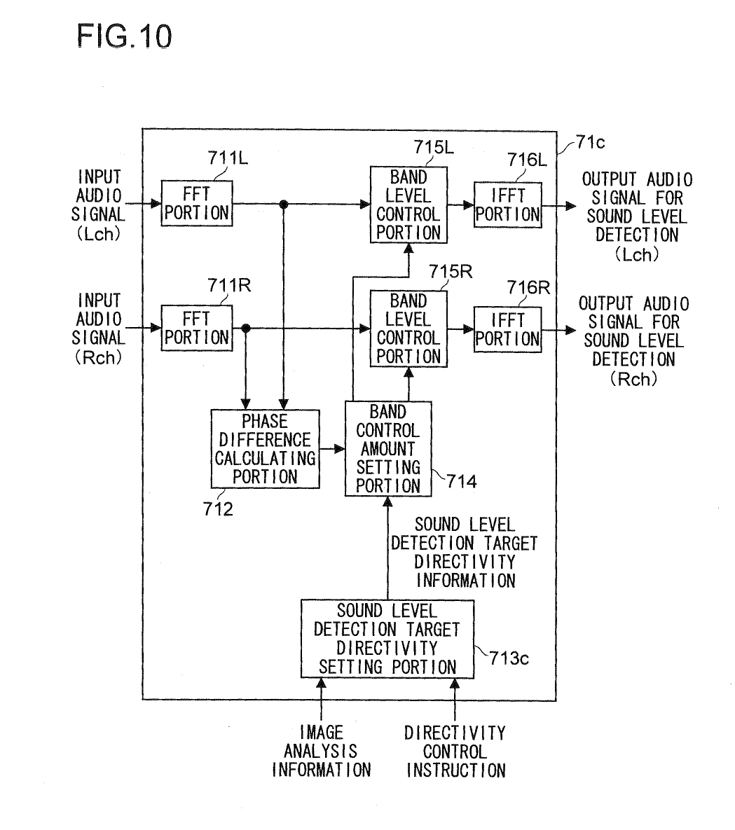

FIG. 10 is a block diagram illustrating a structural example of the directivity control portion for sound level detection in the image audio processing portion of Example 3. The directivity control portion 71c for sound level detection controls the directivity of the input audio signal similarly to the directivity control portion 71 so as to generate the output audio signal for sound level detection. Note that the output audio signal for sound level detection can be interpreted to be a type of the output audio signal, and the directivity control portion 71c for sound level detection can be interpreted to be a type of the directivity control portion 71. In addition, for specific and simplified description hereinafter, it is supposed that the structure of the directivity control portion 71c for sound level detection illustrated in FIG. 10 is similar to the structure of the directivity control portion 71 illustrated in FIG. 3, and a part having the same structure is denoted by the same reference symbol so that a detailed description thereof is omitted.

As illustrated in FIG. 10, the directivity control portion 71c for sound level detection of this example includes the FFT portions 711L and 711R, the phase difference calculating portion 712, a sound level detection target directivity setting portion 713c which sets a sound level detection direction based on the image analysis information and sets a target directivity for sound level detection for extracting sounds coming from the sound level detection direction so as to output the target directivity for sound level detection, the band control amount setting portion 714, the band level control portions 715L and 715R, and the IFFT portions 716L and 716R which output Lch and Rch output audio signals for sound level detection. Note that the sound level detection target directivity setting portion 713c and the sound level detection target directivity information respectively correspond to the target directivity setting portion 713 and the target directivity information in the directivity control portion 71 illustrated in FIG. 3 and can be interpreted as types of the same.

The sound level detection direction means, for example, the direction in which the target subject indicated by the image analysis information exists, that is the direction in which a sound source can exist. Note that the sound level detection direction is not limited to within the angle of view of the input image, but the direction outside the angle of view (e.g., the photographer direction) may be included in the sound level detection direction. In addition, the target directivity for sound level detection means that levels of sounds coming from directions except the sound level detection direction are suppressed (e.g., to be substantially zero).

The sound level detection target directivity setting portion 713c sets the target directivity for sound level detection corresponding to the set sound level detection direction. If a plurality of sound level detection directions are set, the target directivities for sound level detection corresponding to individual sound level detection directions are sequentially switched and set.

Note that it is possible to set the target directivity for sound level detection in association with the target directivity so that levels of sounds coming from individual sound level detection directions are substantially the same in the output audio signal for sound level detection and the output audio signal. With this structure, the sound level of the sound detected by the sound level detection portion 72 that will be described later indicates a sound level of the sound coming from the sound level detection direction in the output audio signal in a preferable manner.

Specifically, as illustrated in FIG. 9, it is possible to adopt a structure in which each of the directivity control portion 71 and the directivity control portion 71c for sound level detection is supplied with an directivity control instruction output from the directivity control instruction converting portion 73 (as described later in detail), so that the target directivity and the target directivity for sound level detection can be controlled in an associated manner. In this case, sound level detection target directivity setting portion 713c changes the setting method of the target directivity based on the directivity control instruction that is supplied similarly to the target directivity setting portion 713, and levels of sounds coming from directions except the sound level detection direction are suppressed as described above. Therefore, even if the directivity of the output audio signal is changed, the directivity of the output audio signal for sound level detection is also changed to follow it. Therefore, the output audio signal for sound level detection indicating the sound level of the sound coming from the sound level detection direction of the output audio signal is output continuously.

In addition, it is possible to adopt a structure in which the photographer issues an instruction via the operating portion 17 to the directivity control portion 71c for sound level detection (in particular, the sound level detection target directivity setting portion 713c), so as to adjust the sound level detection direction (addition or removal of the sound level detection direction, or adjustment of the emphasis direction and the emphasis width).

(Sound Level Detection Portion)

The sound level detection portion 72 detects a sound level of the output audio signal for sound level detection output from the directivity control portion 71c so as to detect a sound level of the sound coming from the sound level detection direction. The detected and obtained sound level is output as the sound level detection information from the sound level detection portion 72 and supplied to the display image generating portion 82c.

Further, if a plurality of target directivities for sound level detection corresponding to a plurality of sound sources are set sequentially in the directivity control portion 71c for sound level detection, the display image generating portion 82c can discriminate which one of the sound sources the input sound level detection information corresponding to.

(Display Image Generating Portion)

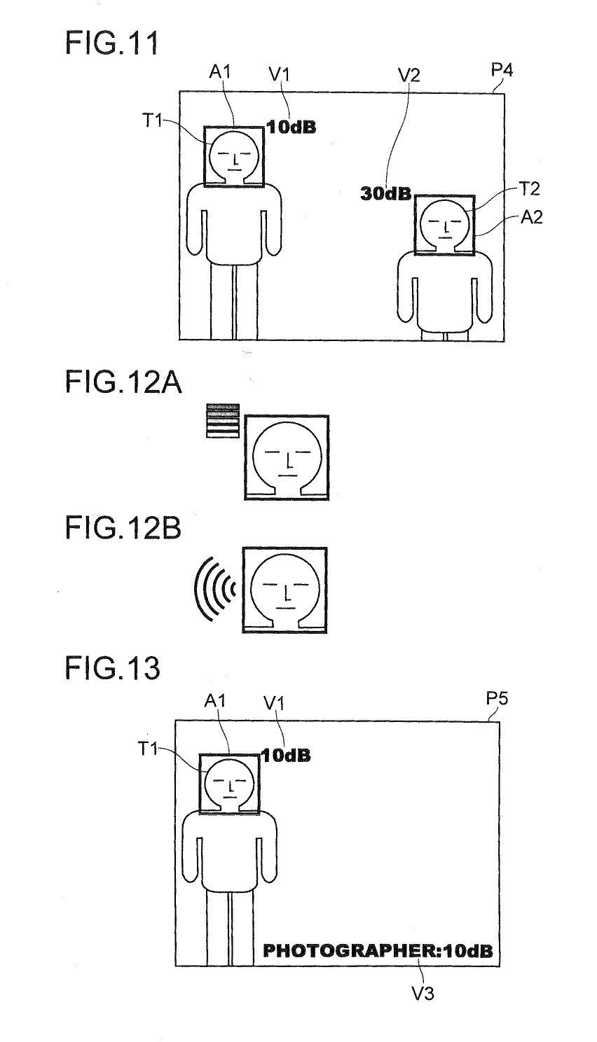

The display image generating portion 82c superimposes the above-mentioned image analysis result image and the image expressing the sound level indicated by the input sound level detection information (hereinafter referred to as a sound level detection result image) on the input image so as to generate the display image. An example of the generated display image is illustrated in FIG. 11. FIG. 11 is a diagram illustrating an example of the display image generated by the display image generating portion in the image audio processing portion of Example 3.

As illustrated in FIG. 11, the display image P4 includes the image analysis result image indicating the target subjects T1 and T2 (face frame images A1 and A2) similar to FIG. 8 and the sound level detection result image (numerical value images V1 and V2) that are superimposed on the input image. In addition, the numerical value image V1 is displayed adjacent to the target subject T1, and the numerical value image V2 is displayed adjacent to the target subject T2.

The numerical value image V1 displays the sound level value detected from the output audio signal for sound level detection when the sound level detection direction is the direction where the target subject T1 exists. In addition, the numerical value image V2 displays the sound level value detected from the output audio signal for sound level detection when the sound level detection direction is the direction where the target subject T2 exists.

Similarly to Example 1 and Example 2, the photographer confirms the display image P4 so as to recognize a state of the output audio signal and changes the setting method of the target directivity in the directivity control portion 71 if necessary, so that the intended output audio signal can be obtained. In this case, it is preferable to adopt a structure in which it is possible to input the sound level specifying instruction for specifying a sound level (e.g., high or low, a target value, and the like) of the output audio signal of a predetermined sound source (e.g., target subjects T1 and T2), so that the output audio signal can easily be controlled. However, in this case, as illustrated in FIG. 9, there is provided the directivity control instruction converting portion 73 for converting the sound level specifying instruction into the directivity control instruction. The directivity control instruction output from the directivity control instruction converting portion 73 is supplied to not only the directivity control portion 71 but also the directivity control portion 71c for sound level detection as described above. Note that it is possible to adopt a structure similar to Example 1 and Example 2, in which the photographer can issue the directivity control instruction directly to the directivity control portion 71 and the directivity control portion 71c for sound level detection.

In addition, since a sound level of the sound generated by the sound source can be confirmed in this example, it is possible to approach a predetermined sound source (e.g., target subjects T1 and T2) or to change a sound collecting environment. By this method, it is also possible to change the input audio signal itself so as to change the state of the output audio signal.

Thus, the photographer can recognize states of sounds (sound levels) generated by the target subjects T1 and T2 specifically when the numerical value images V1 and V2 expressing sound levels generated by the target subjects T1 and T2 detected from the input image are displayed in the display image P4. Therefore, the photographer can easily decide whether or not the intended output audio signal is obtained and can take necessary measures. Therefore, it is possible to generate easily and accurately the output audio signal intended by the photographer.

In addition, since the numerical value images V1 and V2 are displayed adjacent to the corresponding face frame images A1 and A2, it is possible to recognize easily which one of the target subjects T1 and T2 generates the sound whose sound level is displayed. Therefore, it is possible to suppress incorrect recognition in which the photographer recognizes incorrectly a sound generated by one of the target subjects T1 and T2 as the sound generated by the other.

Note that Example 1 and Example 2 may be combined with this example. For instance, it is possible to adopt a structure in which the target directivity information output from the directivity control portion is supplied to the display image generating portion 82c, and the directivity image is displayed in the display image (see FIGS. 4 to 6 and 8). With this structure, it is possible that the photographer confirms the display image and recognizes the target directivity and the sound level at one time. Therefore, it is possible to generate the output audio signal intended by the photographer more easily and accurately.

In addition, it is possible to use the sound level detection result image that expresses the sound level by a method different from that of FIG. 11. Another example of the sound level detection result image will be described with reference to FIGS. 12A and 12B. FIGS. 12A and 12B are diagrams illustrating other examples of the sound level detection result image.

FIG. 12A illustrates an example of the sound level detection result image using a so-called level meter for expressing amplitude of sound level in which a vertical length (the number of blocks) indicates the amplitude of sound level. Note that the level meter increase or decrease in the vertical direction in FIG. 12A, but it is possible to adopt a level meter which increase or decrease in the horizontal direction. FIG. 12B illustrates an example of the sound level detection result image using the number and a length of arc lines for expressing a sound level value. Note that the display increase or decrease in the horizontal direction in FIG. 12B, but it is possible to adopt a display which increase or decrease in the vertical direction.

In this way, if the sound level detection result image expressing the sound level in an abstract manner is used, the photographer can recognize amplitude of the sound level visually and promptly.

In addition, the sound level detection direction may be outside the angle of view of the input image as described above. For instance, it is possible to set the photographer direction to be the sound level detection direction. An example of the display image in the case where the photographer direction is the sound level detection direction will be described with reference to FIG. 13. FIG. 13 is a diagram illustrating another example of the display image generated by the display image generating portion in the image audio processing portion of Example 3.

In the display image P5 illustrated in FIG. 13, similarly to FIG. 11, the target subject T1 is detected and the face frame image A1 and the numerical value image V1 are displayed. Further, a numerical value image V3 is displayed at an end portion of the display image P5 (lower end in this example). The numerical value image V3 expresses a sound level value detect from the output audio signal for sound level detection when the photographer direction is the sound level detection direction.

In this way, if the sound level of the sound coming from a direction outside the angle of view of the input image, particularly from the photographer direction can be displayed, the photographer can recognize a sound level of the sound generated by the photographer outside the angle of view. Therefore, it is possible to generate the output audio signal intended by the photographer more accurately.

In addition, it is possible that the image analysis portion 81 analyzes the input image so as to detect a sound source which exists outside the angle of view of the input image, and to set the direction of the sound source as the sound level detection direction. Specifically, for example, as described above with reference to FIG. 5D, if it is assumed from a result of analysis of the input image that the target subject is talking with the photographer, it is possible to regard the photographer as one of sound sources, so as to set the photographer direction as the sound level detection direction. In addition, it is possible to detect a sound source outside the angle of view by an instruction of the photographer. Further, it is possible to detect a sound source outside the angle of view based on a phase difference of the input audio signal obtained by the phase difference calculating portion illustrated in FIG. 10.

### Other Variation Examples

The generation of the display image and the output audio signal by the image audio processing portions 30a to 30c of Example 1 to Example 3 is performed not only when the output audio signal is recorded like recording of a moving image but also when a preview operation is performed before the recording. If the display image and the output audio signal are generated in the preview operation, it is possible to make a state of the output audio signal (directivity and sound level) be as intended by the photographer in advance. Note that it is possible not to output the output audio signal from the image audio processing portions 30a to 30c in the preview operation.

In addition, the example described above exemplifies the case where the image audio processing portion (image audio processing apparatus) of the present invention is provided to the image sensing apparatus 1 for recording moving images, but it is possible that the image audio processing portion is provided to a reproduction apparatus, so that the directivity of the audio signal is controlled in the reproduction operation. For instance, in this case, the input image signal and the input audio signal may be recorded in a recording medium or input from the outside, so that the display image signal is reproduced by a display device such as a television set. However, it is preferable that display or non-display of the directivity image, the image analysis result image, and the sound level detection result image in the display image can be selected by an instruction from a user.

In addition, as to the image sensing apparatus according to an embodiment of the present invention 1, it is possible that a control unit such as a microcomputer performs the operation of the image audio processing portions 30a to 30c. Further, the whole or a part of the functions realized by the control unit may be described as a program, and the program, so that the whole or a part of the functions is realized by executing the program on an executing unit (e.g., computer).

In addition, without limiting to the above-mentioned cases, the image audio processing portions 30a to 30c of FIGS. 2, 7 and 9 can be realized by hardware or a combination of hardware and software. In addition, when the image audio processing portions 30a to 30c are constituted by using software, the block diagram of the portion realized by software indicates the functional block diagram of the portion.

Although the embodiments of the present invention are described above, the present invention is not limited to the embodiments, which can be modified variously within the scope of the present invention without deviating from the spirit thereof.

The present invention can be applied to an image audio processing apparatus for performing a predetermined process on an input image signal and an audio signal that makes a pair with the image signal so as to output the result, and to an image sensing apparatus such as a digital video camera including the image audio processing apparatus.

What is claimed is:

1. An image audio processing apparatus comprising:
an image analysis portion which analyzes an input image indicated by an input image signal;
a directivity control portion which controls a directivity of an input audio signal that makes a pair with the input image signal based on a result of analysis by the image analysis portion so as to generate an output audio signal; and
a display image generating portion which generates a display image including an image indicating a state of the output audio signal.

2. An image audio processing apparatus according to claim 1, wherein
the image analysis portion detects a target subject from the input image,
the directivity control portion controls the directivity of the input audio signal based on a result of the detection of the target subject by the image analysis portion so as to generate the output audio signal, and
the display image generating portion generates the display image in which the image indicating a directivity of the output audio signal is superimposed on the input image.

3. An image audio processing apparatus according to claim 1, further comprising a sound level detection portion which detects a sound level of an output audio signal, wherein
the image analysis portion detects a target subject from the input image,
the directivity control portion suppresses sounds coming from directions other than the direction in which the target subject exists in the input audio signal so as to generate the output audio signal, and
the display image generating portion generates the display image in which an image indicating a sound level of the output audio signal detected by the sound level detection portion is superimposed on the input image.

4. An image audio processing apparatus according to claim 2, wherein the display image generating portion generates a display image by superimposing an image indicating a position of the target subject in the input image on the input image.

5. An image audio processing apparatus according to claim 1, further comprising:
a sound level detection portion which detects a sound level of the output audio signal; and
a sound source direction detection portion which detects a direction in which a sound source outside an angle of view in the input image exists, wherein
the directivity control portion suppresses sounds coming from directions other than the direction in which the sound source outside the angle of view in the input audio signal exists so as to generate the output audio signal, and
the display image generating portion generates the display image in which an image indicating a sound level of the output audio signal detected by the sound level detection portion is superimposed on the input image.

6. An image sensing apparatus comprising:
an image audio processing apparatus according to claim 1;
an image sensing portion which generated an input image signal by image sensing;
a sound collecting portion which generated an input audio signal by sound collecting; and
a display portion which display a display image.
